(19) United States
(12) Patent Application Publication
(10) Pub. No.: US 2013/0268332 A1
(43) Pub. Date: Oct. 10, 2013

(54) SYSTEMS AND METHODS FOR ENHANCING CUSTOMER SERVICE

(71) Applicants: Erika Chyu, New York, NY (US); Eric Ho, Jersey City, NJ (US); Scott Roen, Ridgewood, NJ (US)

(72) Inventors: Erika Chyu, New York, NY (US); Eric Ho, Jersey City, NJ (US); Scott Roen, Ridgewood, NJ (US)

(73) Assignee: American Express Travel Related Services Company, Inc., New York, NY (US)

(21) Appl. No.: 13/439,640

(22) Filed: Apr. 4, 2012

(51) Int. Cl. G06Q 30/02; G06Q 30/06

(52) U.S. Cl. 705/14.17; 705/304; 705/26.1; 705/14.4; 705/14.49

(57) ABSTRACT

A method is disclosed for determining that a consumer is within an area encompassing a merchant. A visual description of the consumer is transmitted to the merchant. Consumer status information is transmitted to the merchant. The method may include determining that the consumer satisfies offer criteria. A promotion offer may he transmitted to the consumer. The merchant may use the visual description or consumer preferences to offer the consumer a personalized product or service.

### BACKGROUND

1. Field of the disclosure

The present disclosure generally relates to the field of providing customer services, and more particularly, to enhancing the services provided by a merchant to a consumer.

2. Related Art

Many business entities provide customer services to ensure higher customer satisfaction. Indeed, certain business entities sometimes differentiate themselves from the competition by providing a better customer service. The business entities provide various offers, loyalty programs, and/or rewards points on their products and services in order to acquire and retain consumers. As used herein, such offers are collectively referred to as merchant offers.

Some wet services available in the market attempt to drive consumers into stores by providing merchant offers from various merchants. Information concerning the products and services of the participating merchants and associated merchant offers is uploaded on an online portal. Such portals form an interface between the consumers and the merchants by providing a platform bringing together a plurality of consumers and a plurality of merchants. While these portals are usually able to provide merchant offers to a large number of consumers, the recommended products/services may not always be the most relevant to the consumers as these portals often fail to take the consumers' transaction history into account.

On the other hand, the merchants typically run targeted marketing campaigns to market their products/services to prospective consumers. The merchants often utilize data obtained from third party service providers to identify the prospective consumers and distribute marketing material to the prospective consumers. Third party service providers typically include credit card companies, credit rating agencies, and the like. Running a targeted marketing campaign in this manner may be very expensive, especially for small merchants. Further, the prospective consumers are generally identified using some demographic criteria, while transaction behavior of the consumers is ignored. Consequently, such marketing campaigns may not be very effective.

Given the foregoing, what is needed is a system, a method and an article of manufacture for enhancing the services provided by a merchant to a consumer.

### SUMMARY

The present disclosure includes systems, methods, and articles of manufacture for enhancing customer service. The method may comprise determining that a consumer is within an area encompassing a merchant, transmitting a visual description of the consumer to the merchant, and transmitting consumer status information associated with the consumer to the merchant. The consumer status information may include at least one of cardmember status, a social media score, a job title, an income level, prior purchasing history, a credit score, new customer status, available credit, or any other information that allows the merchant to target the consumer.

In various embodiments, the information may be transmitted to the merchant via a phone call, fax, text, email message or any other communication disclosed herein or known in the art. The information may also be transmitted to a web client operated by the merchant. The merchant may use the information to segment consumers into groups. The merchant may determine that the consumer satisfies offer criteria. The merchant may offer a promotion to the consumer in response to the consumer satisfying the offer criteria. The promotion may be transmitted to a consumer's mobile device.

The visual description may include a photograph and/or textual description of the consumer. The merchant may use the visual description to identify the consumer and treat the consumer with a personalized experience. The method may include transmitting consumer preferences to the merchant and the merchant may use the consumer preferences to offer specific products or services to the consumer.

The method may include receiving a notification from the consumer that the consumer is in the area of the merchant or arriving at the merchant location. The method may include monitoring a location of the consumer mobile device via (IPS technology and determining that the consumer is in the area encompassing the merchant. The method may further include determining that the consumer has left the area and, in response, authorizing a transaction request associated with the consumer and the merchant.

The method may include analyzing social media relationships associated with the consumer and analyzing social media relationships associated with the merchant. The method may include comparing the social media relationships associated with the merchant and the social media relationships associated with the merchant. The method may also include notifying the merchant of a relationship between the consumer and the merchant.

The method may include receiving a request to offer the consumer a promotion from the merchant and transmitting the promotion to the consumer. The method may further include storing a response to the promotion and rewarding loyalty points to the consumer based on the response. The method may include matching an accepted promotion with a record of charge to a transaction account held by the consumer and crediting the transaction account based upon the matching. The method may further include enrolling the merchant in a customer enhancement program and enrolling the consumer in the customer enhancement program.

Further features and advantages of the present disclosure as well as the structure and operation of various embodiments of the present disclosure are described in detail below with reference to the accompanying drawings.

### BRIEF DESCRIPTION OF THE DRAWINGS

A more complete understanding of the disclosure may be derived by referring to the detailed description and claims when considered in connection with the FIGS, wherein like reference numbers refer to similar elements throughout the FIGS, and:

FIG. 1 is an overview of a system in which a customer service system may be deployed, in accordance with various embodiments;

FIG. 2 is a schematic of a block diagram of the customer service system, in accordance with various embodiments;

FIG. 3 is a schematic illustration of an interface at the merchant's end, according to various embodiments;

FIG. 4 is a flowchart illustrating a method of providing customer services by the merchant, in accordance with various embodiments; and

FIG. 5 is a block diagram of a computer system for implementing the present disclosure, in accordance with various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present disclosure is directed to systems, methods and articles of manufacture for enhancing services provided by the merchant to the consumer. A computer-based system is provided to enhance customer service by providing information associated with the consumer to the merchant. The information associated with the consumer may include, without limitation, transaction history, geographic location of the consumer, a social media score, a job title, an income level, and the like. Various embodiments are aimed at providing customized merchant offers to the consumers in a convenient manner. Further, various embodiments also provide the merchants customized marketing solutions enabling them to reach out to the potential consumers in an organized and effective manner.

The phrases consumer, customer, account holder, cardmember or the like shall include any person, entity, government organization, business, machine associated with a transaction account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

A “merchant” generically refers to any provider offering one or more products and/or services to a plurality of consumers. In various embodiments, the merchant may be an individual, a group of individuals, a corporate firm, government organization and the like. Further, the terms “seller”, “provider”, “vendor” “merchant” have been used interchangeably in this disclosure.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

In various embodiments, the plurality of consumers may be transaction card holders (i.e. card members). Examples of the transaction card include, but are not limited to, credit cards, debit cards, pre-paid cards, charge cards, gift cards and the like. The transaction cards may be issued by a transaction card issuer, for example, American Express.

The terms “merchant offerings”, “products”, “services” and the like have been used interchangeably in this disclosure and may refer to any kind of service or product offered by the merchant. Further, the offers, loyalty programs, reward points, coupons provided by the merchants on merchant offerings have been collectively referred to as “merchant offers” in this disclosure.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

As used herein, “transmit” may include sending electronic data from one system component to another over a network connection. Additionally, as used herein, “data” may include encompassing information such as commands, queries, files, data for storage, and the like in digital or any other form,

In different embodiments, one or more of the consumers may also be offering products/services. Similarly, one or more of the merchants may also be consumers of some products/services. Thus, the terms “consumer” and “merchant” are context specific and represent a consumer of products/services and a provider of products/services, respectively, for a particular context. In a different context, their respective roles may switch. For example, a merchant in one situation may be a consumer in another and vice versa,

The present disclosure is now described in terms of an exemplary system, hereinafter referred to as a customer service system, in which the present disclosure may be implemented. In various embodiments, customer service system may be deployed by any entities such as, but not limited to, merchants, transaction card issuers, third party service providers and the like. The nomenclature used herein is for convenience only and is not intended to limit the application of the present disclosure. It will be apparent to one skilled in the relevant art(s) how to implement the present disclosure in alternative embodiments.

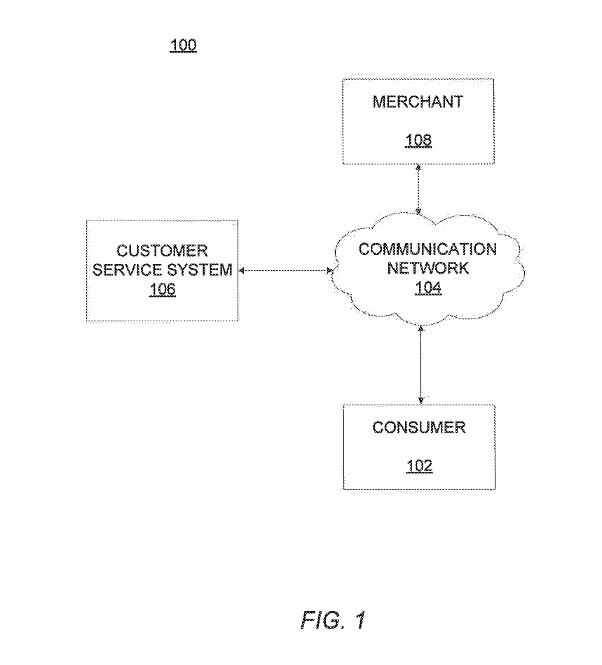

With reference to FIG. 1, in various embodiments, a system 100 may include a customer service system 106. The system 100 may further include a consumer 102, a communication network 104, and a merchant 108.

Communication network 104 may provide a communication link between the merchant 108 and the consumer 102. Communication network 104 may be capable of providing the voice and data communications capabilities. Examples of communication network 104 may include, but are not limited to, a wide area network (WAN), a local area network (LAN), an Ethernet, Internet, an Intranet, a cellular network, a satellite network, Public Switched Telephony Network (PSTN) or any other suitable network for transmitting data/voice. Communication network 104 may be implemented as a wired network, or a wireless network or a combination thereof.

The consumer 102 and/or the merchant 108 may communicate (in any manner discussed herein) with the customer service system 106 via communication network 104 using any of known communication devices such as, without limitation, a computer, a mobile phone, a Personal Digital Assistant (PDA), a laptop, a pocket PC and the like. The communication devices may comprise any hardware and/or software suitably configured to facilitate input, receipt and/or review of information discussed herein.

In various embodiments, the customer service system 106 may provide visual description of the consumer 102 to the merchant 108. The merchant 108 may use the visual description, such as photograph, to identify the consumer 102 and treat the consumer 102 with a personalized experience. The customer service system 106 may transmit consumer status information associated with the consumer 102 to the merchant 108. The customer status information may include at least one of cardmember status, a social media score, a job title, an income level, prior purchasing history, a credit score, new customer status, available credit, or any other information that allows the merchant 108 to target the consumer 102. Using the consumer status information, the merchant 108 may create customized merchant offers for the consumer 102.

In various embodiments, the customer service system 106 may transmit information to a web client (not shown) operated by the merchant 108. A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the Internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

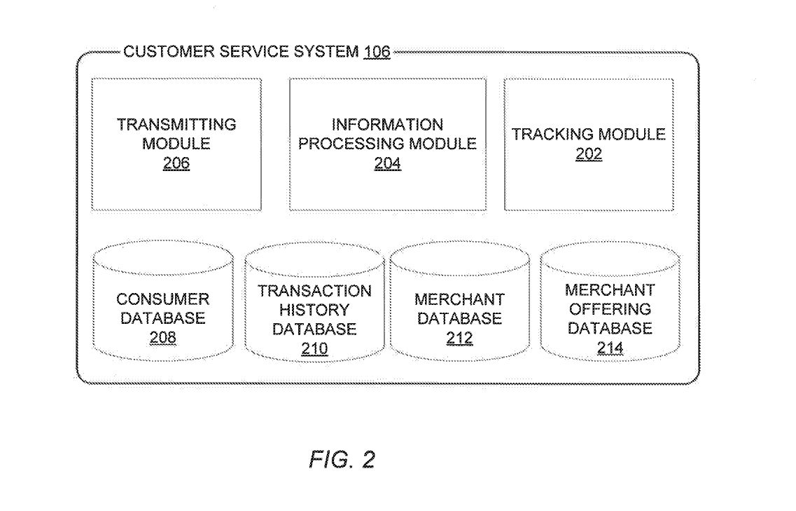

With reference to FIG. 2, the customer service system 106 includes a tracking module 202, an information processing module 204, and a transmitting module 206. The customer service system 106 further includes a consumer database 208, a transaction history database 210, a merchant database 212, and a merchant offering database 214. In various embodiments, the customer service system 106 may be operated by a transaction account issuer.

The tracking module 202 may determine presence of the consumer 102 in the area encompassing the merchant 108. For this, the tracking module 202 may monitor location of a mobile device of the consumer 102. Some examples of the mobile device of the consumer 102 include, but are not limited to, smartphones, tablets, and laptops. In various embodiments, the tracking module 202 may use a global positioning application (e.g. GPS) to monitor location of the mobile device of the consumer 102. In various embodiments, the tracking module 202 may use the location of wireless hotspots, cellular base stations, and so forth, to monitor location of the mobile device of the consumer 102, for example, using suitable triangulation methods.

Based on the location, the tracking module 202 may determine whether the consumer 102 is located within the geographic area covered by the merchant 108. In various embodiments, tracking module 202 may receive a notification that the consumer 102 is present in the area. The notification may be sent by the consumer 102 or an external service provider monitoring location of the mobile device. The customer service system 106 may then notify the merchant 108 that the consumer 102 has arrived in the area. In various embodiments, the tracking module 202 may determine that the consumer 102 has left the area encompassed by the merchant 108. In response, the customer service system 106 may authorize a transaction request associated with the consumer 102 and the merchant 108. The transaction request may include a discount or rebate coupon, reward points, and so forth.

The information processing module 204 may gather data associated with the consumer 102. In various embodiments, the information processing module 204 may query the consumer database 208 and/or the transaction history database 210 to obtain data associated with the consumer 102. The consumer database 208 may obtain data associated with the consumer from a variety of sources. In various embodiments, the consumer may transmit information to the customer service system 106 which stores the information in the consumer database 208. The consumer database 208 may receive internal data from a transaction account issuer. The consumer database 208 may receive information associated with consumer 102 from third parties such as credit reporting agencies. The consumer database 208 may store various types of information associated with the consumer 102. In various embodiments, visual description of the consumer 102 may be stored in the consumer database 208. The visual description may include, without limitation, a photograph and/or a textual description of the consumer 102.

According to various embodiments, the information processing module 204 may check whether the consumer 102 is already registered with the customer service system 106. If not, the consumer 102 may be registered with the customer service system 106 as a new consumer, and the information processing module 204 may create the new consumer's profile. In various embodiments, to create a profile for the new consumer, the information processing module 204 may obtain data associated with the new consumer. For this, the information processing module 204 may query the new consumer to obtain data. Alternatively, the information processing module 204 may obtain data from third party providers such as, but not limited to, credit card companies, credit rating agencies, and social media websites. The data associated with the new consumer may be saved in the consumer database 208.

Further, the information processing module 204 may obtain consumer status information associated with the consumer 102. The consumer status information may include at least one of cardmember status, a social media score, a job title, an income level, prior purchasing history, a credit score, new customer status, available credit, or any other information that allows the merchant 108 to target the consumer 102. In various embodiments, the consumer status information may be obtained from the consumer database 208. Additionally, the consumer status information may be obtained from various third party providers such as, but not limited to, credit card companies, credit rating agencies, and social media websites.

The information processing module 204 may obtain data about transactions between the consumer 102 and the merchant 108, according to various embodiments. Transaction data for a transaction may include one or more of name of consumer, name of merchant, type of purchased product and/or service, location of purchase, date of purchase, quantity of purchase, amount spent, description of the merchant, mode of payment, transaction card details and the like. In various embodiments, the information processing module 204 may also obtain transaction data associated with the consumer 102 from third party service providers such as credit card companies, credit rating agencies, and the like. Data obtained from third party providers includes, without limitation, consumer spend behavior, credit score, payment history, preferred merchants, frequency of purchases, and the like. The information processing module 204 may store transaction data in the transaction history database 210.

After receiving the transaction data about a recent transaction, the information processing module 204 may update appropriate profiles of the consumer 102 and the merchant 108 associated with the transaction, according to various embodiments. The information processing module 204 may analyze the transaction data of the current transaction and historical transaction data of the consumer 102 to create consumer groups and assign appropriate groups to the consumer 102, thereby updating the profile of the consumer 102. Further, according to various embodiments, the information processing module 204 may check whether product(s) and/or service(s) present in the transaction and the merchant 108 are already stored in respective databases. If the product(s) and/or service(s) are not present, merchant offering data for the merchant 108 is updated in the merchant offering database 214. Further, profile of the merchant 108 is also suitably updated and stored in the merchant database 212.

In various embodiments, the customer service system 106 enables the consumer 102 and the merchant 108 to specify respective buying and selling preferences. These preferences may be stored in the consumer database 208 and the merchant database 212, respectively. Further, the customer service system 106 may give to the consumer 102 and the merchant 108, an option of altering personal information. The personal information for the consumer 102 may include information such as, name, address, age, gender, annual income, marital status, family information, billing details and the like. The personal information for the merchant 108 may include details such as, name, address, size of company, annual revenue, annual profit, contact details of point of sales etc. The consumer database 208 may store the personal information of the plurality of consumers. Similarly, the merchant database 212 may store the personal information of the plurality of merchants. The customer service system 106 may transmit consumer preferences to the merchant 108, and merchant 108 may use the consumer preferences to select an offer to transmit to consumer 102.

The transmitting module 206 may transmit a visual description of the consumer 102 to the merchant 108. In various embodiments, the visual description may include the photograph and/or the textual description of the consumer 102. The visual description may comprise any information which assists in identifying the consumer 102. For example, the visual description may comprise the age and gender of the consumer 102. Transmission of visual description may include at least one of calling or transmitting an electronic message to the merchant 108. The merchant 108 may use the visual description to identify the consumer 102. Upon identifying the consumer 102, the merchant 108 may offer a personalized experience to the consumer 102.

Further, the transmitting module 206 may transmit consumer status information associated with the consumer 102 to the merchant 108. The consumer status information may include at least one of cardmember status, a social media score, a job title, an income level, prior purchasing history, a credit score, new customer status, available credit, or any other information that allows a merchant to target a consumer. In various embodiments, the transmitting module 206 may transmit preferences of the consumer 102 to the merchant 108. The transmitting module 206, in various embodiments, may transmit information to the merchant 108 via a phone call, fax, text message, email message or any other communication method known in the art,

According to various embodiments, the information processing module 204 may analyze social media relationships associated with the consumer 102 and/or the merchant 108. The consumer database 208 and the merchant database 212 may store social media relationships associated with the consumer 102 and the merchant 108 respectively. The information processing module 204 may compare the social media relationships associated with the consumer 102 to the social media relationships associated with the merchant 108. A person skilled in the art will recognize that various social media relationships known in the art may be associated with the consumer 102 and/or the merchant 108. Based on the comparison, the information processing module 204 may identify social media relationships between the consumer 102 and the merchant 108. For example, the information processing module 204 may determine that the consumer 102 is related to an owner or employee of merchant 108. Further, the information processing module 204 may notify the merchant 108 of a relationship between the consumer 102 and the merchant 108.

The merchant 108 may utilize the data provided by the customer service system 106 to segment consumers into one or more groups. Further, the merchant 108 may determine that the consumer 102 satisfies one or more offer criteria. The offer criteria may include at least one of cardmember status, a social media score, a job title, an income level, prior purchasing history, a credit score, new customer status, and available credit. In response to the consumer 102 satisfying the offer criteria, the merchant 108 may present an offer to the consumer 102. In various embodiments, the promotion may be directly transmitted by the merchant 108 to mobile device of the consumer 102. Alternatively, the merchant 108 may request the customer service system 106 to offer the promotion to the consumer 102. In response, the customer service system 106 may transmit the offer to mobile device of the consumer 102. In various embodiments, the customer service system 106 may store a response to the offer from the consumer 102. Based on the response, loyalty points may be rewarded to the consumer 102. In various embodiments, the customer service system 106 may match an accepted offer with a record of charge to a transaction account held by the consumer 102. Based upon results of the matching, the transaction account of the consumer 102 may be credited with the rewarded loyalty points.

In various embodiments, merchant 108 or customer service system 106 may track interactions between consumer 102 and merchant 108. Customer service system 106 may track information such as a number of consumer visits, frequency of consumer visits, amount of consumer purchases, number of visits from consumers connected via social media to consumer 102, etc. In various embodiments, merchant 108 or customer service system 106 may provide a reward to the consumer in response to the interactions. For example, a reward may comprise loyalty points, a discount on goods or services, cash, upgrades in service, or any other type of reward. As such, merchant 108 may be able to promote loyalty among its consumers.

In various embodiments, the merchant 108 may carry out processing on the data provided by the customer service system 106 to create customized offers for the consumer 102. The merchant 108 may collate data regarding consumers tracked via the customer service system 106, consumers currently in store. Most Valuable Persons (MVPs), new consumers, and the like. The merchant 108 may use a dashboard to allow custom segmentation of consumers and create personalized offers for the consumer 102. For example, the merchant 108 may present “Buy One Get One Free” offer for all consumers nearby that visited the store more than 10 times in last 30 days. In various embodiments, the merchant 108 may push customized offers to the consumer 102 present in the area encompassed by the merchant 108. Mobile device of the consumer 102 may receive push notifications of customized offers. The consumer 102 may tap on the received notification to view details of the offer. Finally, the consumer 102 may walk into the store of the merchant 108 and redeem the offer.

In various embodiments, the merchant 108 may ask the customer service system 106 to create customized offers for the consumer 102. To facilitate this, the information processing module 204 may obtain merchant offerings data associated with the merchant 108. The merchant offerings data for the merchant 108 may include at least one of one or more goods (that is, products), one or more services provided by the merchant, pricing information, geographic location associated with the products/services, information about the products and/or services, merchant offers, experience(s) associated with the products/services, a description associated with the products and/or services and the like. The information processing module 2.04 may store the merchant offering data in the merchant offering database 214. To create customized offers for the consumer 102, the information processing module 204 may utilize merchant offering data from the merchant offering database 214, merchant data from the merchant database 212, consumer data from the consumer database 208 and transaction data from the transaction history database 210,

In various embodiments, consumer 102 may use customer service system 106 to schedule a reservation at a restaurant or other establishment of merchant 108. Customer service system 106 may determine that consumer 102 has arrived at the establishment and notify merchant 108 that the consumer 102 is present. Customer service system 106 may also transmit a visual description of consumer 102.

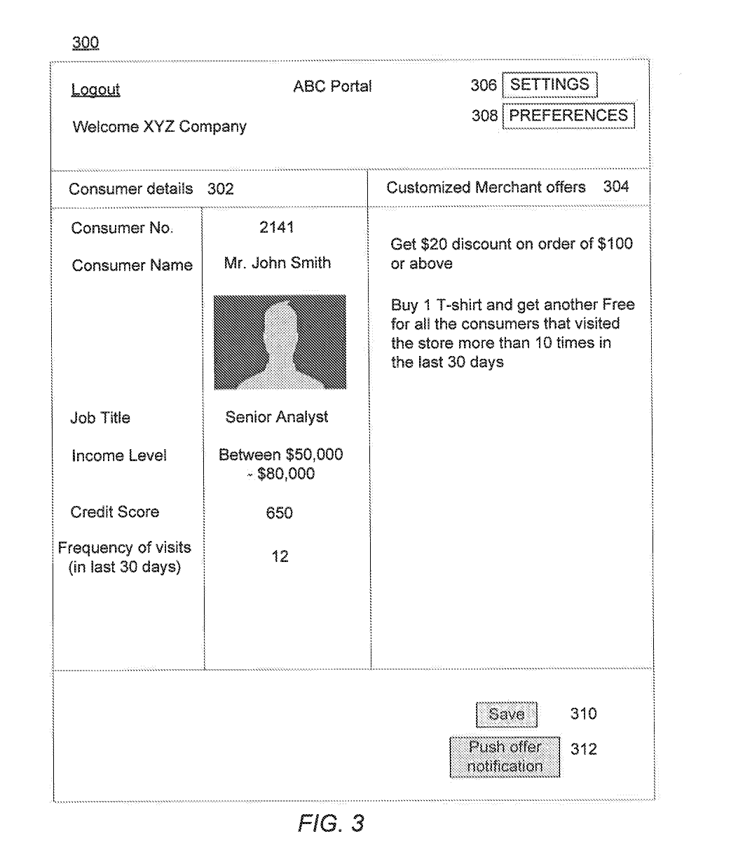

FIG. 3 illustrates an interface 300 for presenting the consumer information to the merchant 108. The column 302 shows an exemplary view of the details of the consumer 102. In various embodiments, column 304 is used for displaying the customized merchant offers.

As shown, column 302 displays various details of the consumer 102, here, Mr. John Smith. In the current example, the column 302 shows consumer number, consumer name, photograph of the consumer, job title, income level and credit score. A person skilled in the art will recognize various other consumer details known in the art to create customized offers for the consumer 102.

Column 304 shows an exemplary view of the customized merchant offers provided by the merchant 108. In the current example, the merchant 108 provides “Buy I T-shirt and get another Free” offer for all the consumers that visited the store more than 10 times in the last 30 days.

In various embodiments, the interface 300 may also include buttons such as, SETTINGS 306 and PREFERENCES 308 for allowing the merchant 108 to modify the settings and the preferences, respectively. In various embodiments, in response to the merchant 108 clicking on the SETTING 306 button, a separate interface is provided to the merchant 108 to enable the merchant 108 to modify the settings. The separate interface may be provided in the same web page or a new web page may be opened. In various embodiments, the settings may include options for changing details such as, password, credit card details, mailing address and the like. Similarly, the merchant 108 may need to click on the button PREFERENCES 308 to modify the preferences.

In various embodiments, the interface 300 may further include buttons SAVE 310 and PUSH OFFER NOTIFICATION 312. In various embodiments the SAVE 326 button may enable the merchant 108 to save the selection of the merchant offers for a possible modification at a later point in time. In various embodiments, on clicking the PUSH OFFER. NOTIFICATION 312 button, the merchant 108 may push a customized offer to the consumer 102..

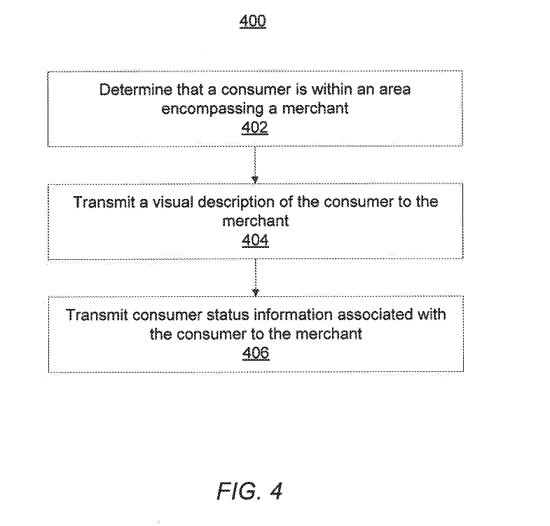

With reference to FIG. 4, the consumer 102 may access the customer service system 106 by supplying appropriate credentials, for example, a username and a password. In various embodiments, the consumer 102 may send a notification of arrival in the area to the customer service system 106. The consumer 102 may generate the notification of arrival explicitly, for example, by clicking on an appropriate button on a user interface. In various embodiments, the notification of arrival may be implicit and may be generated when the consumer 102 logs into the customer service system 106. The customer service system 106 may forward the notification of arrival of the consumer 102 to the merchant 108.

The customer service system 106 determines that the consumer 102 is within the area encompassed by the merchant 108 (step 402). For this, the customer service system 106 may monitor location of the mobile device of the consumer 102 using a global positioning application (e.g. (GPS). A person skilled in the art will recognize various other techniques known in the art to monitor location of the mobile device. Based on the location, the customer service system 106 may determine that the consumer 102 is present in the area encompassed by the merchant 108. In various embodiments, the customer service system 106 may determine that the consumer 102 has left the area encompassed by the merchant 108. In response, the customer service system 106 may authorize a transaction request associated with the consumer 102 and the merchant 108.

In various embodiments, the consumer 102 may be required to opt-in to the customer service system 106 in order to participate in customer service system 106. Thus, if the consumer does not opt-in, the customer service system 106 may not be able to geographically locate the consumer 102, or transmit information about the consumer 102 to the merchant 108. In various embodiments, the consumer 102 may opt-out at any time after opting-in.

The customer service system 106 then transmits the visual description of the consumer 102 to the merchant 108 (step 404). The visual description may include a photograph and/or textual description of the consumer 102. The customer service system 106 may obtain the visual description of the consumer 102 from the consumer database. In various embodiments, the customer service system 106 may transmit visual description of the consumer 102 by calling the merchant 108 or transmitting an electronic message to the merchant 108. The merchant 108 may use the visual description to identify the consumer 102 and treat the consumer 102 with a personalized experience.

Further, the customer service system 106 may transmit consumer status information to the merchant 108 (step 406). The consumer status information may include information obtained from the transactions at the stores of the merchant 108. The consumer status information may also include information obtained from the third party providers such as credit card companies, credit rating agencies, and the like. Further, information obtained from the transaction history database 210 may be included in the consumer status information. The consumer status information may include at least one of cardmember status, a social media score, a job title, an income level, prior purchasing history, a credit score, new customer status, available credit, or any other information that allows a merchant to target a consumer. In various embodiments, the customer service system 106 may transmit preferences of the consumer 102 to the merchant 108.

In various embodiments, the information may be transmitted to the merchant 108 via a phone call, fax, text, email message or any other communication disclosed herein or known in the art. The information may also be transmitted to the web client operated by the merchant 108.

The merchant 108 may utilize the information provided by the customer service system 106 to determine that the consumer 102 satisfies offer criteria. The offer criteria may include at least one of cardmember status, a social media score, a job title, an income level, prior purchasing history, a credit score, new customer status, and available credit. In response to the consumer 102 satisfying the offer criteria, the merchant 108 may offer a promotion to the consumer 102. In various embodiments, the promotion may be directly transmitted by the merchant 108 to mobile device of the consumer 102. Alternatively, the merchant 108 may request the customer service system 106 to offer the promotion to the consumer 102.

In various embodiments, the merchant 108 may carry out processing on the information provided by the customer service system 106 to create customized offers for the consumer 102. To begin with, the merchant 108 may collate data of consumers tracked via the customer service system 106, consumers currently in store, Most Valuable Persons (MVPs), new consumers, and the like. The merchant 108 may use a dashboard to allow custom segmentation of consumers and create personalized offers for the consumer 102. In various embodiments, the merchant 108 may push customized offers to the consumer 102 present in the area encompassed by the merchant 108. The mobile device of the consumer 102 may receive push notifications of customized offers. The consumer 102 may tap on the received notification to view details of the offer. Finally, the consumer 102 may walk into the store of the merchant 108 and redeem the offer.

While the steps outlined above represent a specific embodiment of the disclosure, practitioners will appreciate that there are any number of computing algorithms and user interfaces that may be applied to create similar results. The steps are presented for the sake of explanation only and are not intended to limit the scope of the disclosure in any way.

The present disclosure (Le., system 100, customer service system 106, process 400 or any part(s) or function(s) thereof) may be implemented using hardware, software or a combination thereof, and may be implemented in one or more computer systems or other processing systems. However, the manipulations performed by the present disclosure were often referred to in terms, such as comparing or checking, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers or similar devices.

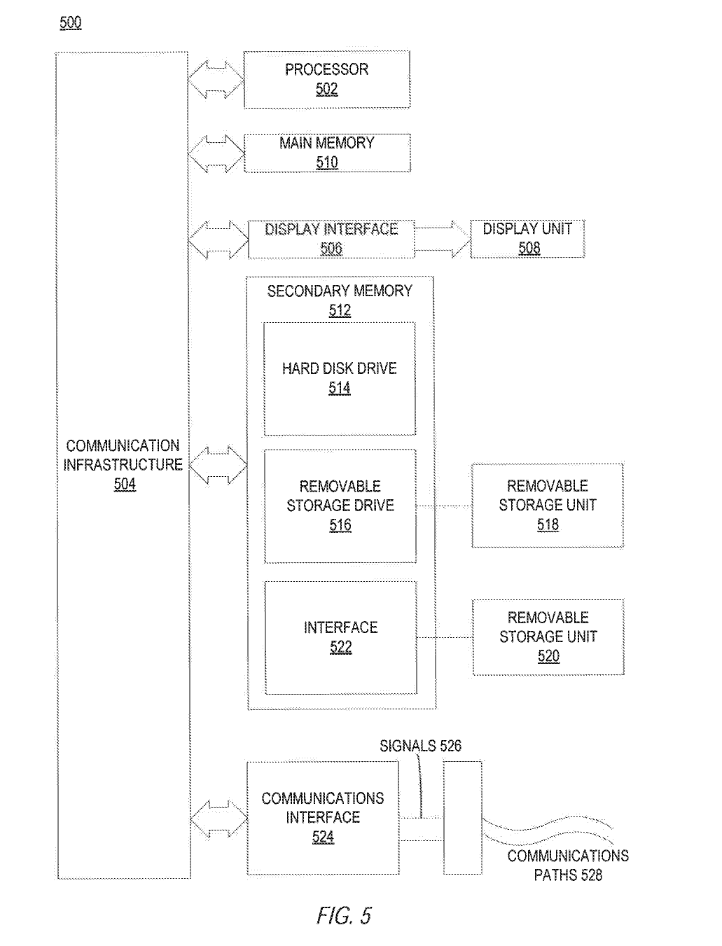

In accordance with various embodiments of the present disclosure, the present disclosure is directed towards one or more computer systems capable of carrying out the functionality described herein. An example of the computer systems includes a computer system 500, which is shown in FIG. 5,

The computer system 500 includes at least one processor, such as a processor 502. Processor 502 is connected to a communication infrastructure 504, for example, a communications bus, a cross over bar, a network, and the like. Various software embodiments are described in terms of this exemplary computer system 500. After reading this description, it will become apparent to a person skilled in the relevant art(s) how to implement the present disclosure using other computer systems and/or architectures.

The computer system 500 includes a display interface 506 that forwards graphics, text, and other data from the communication infrastructure 504 (or from a frame buffer which is not shown in FIG. 5) for display on a display unit 508.

The computer system 500 further includes a main memory 510, such as random access memory (RAM), and may also include a secondary memory 512. The secondary memory 512 may further include, for example, a hard disk drive 514 and/or a removable storage drive 516, representing a floppy disk drive, a magnetic tape drive, an optical disk drive, etc. The removable storage drive 516 reads from and/or writes to a removable storage unit 518 in a well known manner. The removable storage unit 518 may represent a floppy disk, magnetic tape or an optical disk, and may be read by and written to by the removable storage drive 516. As will be appreciated, the removable storage unit 518 includes a computer usable storage medium having stored therein, computer software and/or data.

In accordance with various embodiments, the secondary memory 512 may include other similar devices for allowing computer programs or other instructions to be loaded into the computer system 500. Such devices may include, for example, a removable storage unit 520, and an interface 522. Examples of such may include a program cartridge and cartridge interface (such as that found in video game devices), a removable memory chip (such as an erasable programmable read only memory (EPROM), or programmable read only memory (PROM)) and associated socket, and other removable storage units 520 and interfaces 522, which allow software and data to be transferred from the removable storage unit 520 to the computer system 500,

The computer system 500 may further include a communication interface 524. The communication interface 524 allows software and data to be transferred between the computer system 500 and external devices. Examples of the communication interface 524 include, but may not be limited to a modem, a network interface (such as an Ethernet card), a communications port, a Personal Computer Memory Card International Association (PCMCIA) slot and card, and the like. Software and data transferred via the communication interface 524 are in the form of a plurality of signals, hereinafter referred to as signals 526, which may be electronic, electromagnetic, optical or other signals capable of being received by the communication interface 524. The signals 526 are provided to the communication interface 524 via a communication path (e.g., channel) 528. A communication path 528 carries the signals 526 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 516, a hard disk installed in hard disk drive 514, the signals 526, and the like. These computer program products provide software to the computer system 500. The present disclosure is directed to such computer program products,

Computer programs (also referred to as computer control logic) are stored in the main memory 510 and/or the secondary memory 512. Computer programs may also be received via the communication infrastructure 504. Such computer programs, when executed, enable the computer system 500 to perform the features of the present disclosure, as discussed herein. In particular, the computer programs, when executed, enable the processor 502 to perform the features of the present disclosure. Accordingly, such computer programs represent controllers of the computer system 500.

In accordance with various embodiments of the disclosure, where the disclosure is implemented using a software, the software may be stored in a computer program product and loaded into the computer system 500 using the removable storage drive 516, the hard disk drive 514 or the communication interface 524. The control logic (software), when executed by the processor 502, causes the processor 502 to perform the functions of the present disclosure as described herein.

In various embodiments, the present disclosure is implemented primarily in hardware using, for example, hardware components such as application specific integrated circuits (ASIC). Implementation of the hardware state machine so as to perform the functions described herein will be apparent to persons skilled in the relevant art(s). In various embodiments, the present disclosure is implemented using a combination of both the hardware and the software.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

One skilled in the art will appreciate that the customer service system 106 may employ any number of databases in any number of configurations. Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation. (Redwood Shores, Calif.). Microsoft Access or Microsoft SQL Server by Microsoft Corporation (Redmond, Wash.), MySQL by MySQL AB (Uppsala, Sweden), or any other suitable database product. Moreover, the databases may he organized in any suitable manner, for example, as data tables or lookup tables. Each record may be a single file, a series of files, a linked series of data fields or any other data structure. Association of certain data may he accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the customer service system 106, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e,g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e,g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e,g., networks, servers, storage, applications, and services) that can be rapidly provisioned and released with minimal management effort or service provider interaction. Cloud computing may include location-independent computing, whereby shared servers provide resources, software, and data to computers and other devices on demand, For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

In various embodiments, components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like, The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may he configured to request a response from the operating system which monitors various hardware components and then communicates a detected input from the hardware to the micro-app.

The data, including the header or trailer may be received by a stand-alone interaction device configured to add, delete, modify, or augment the data in accordance with the header or trailer. As such, in various embodiments, the header or trailer is not stored on the transaction device along with the associated issuer-owned data but instead the appropriate action may be taken by providing to the transaction instrument user at the stand-alone device, the appropriate option for the action to be taken.

One skilled in the art will also appreciate that, for security reasons, any databases, systems, devices, servers or other components of the customer service system 106 may consist of any combination thereof at a single location or at multiple locations, wherein each database or system includes any of various suitable security features, such as firewalls, access codes, encryption, decryption, compression, decompression, and/or the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.2.34). The web server retrieves the appropriate web pages and sends the data or applications for the web pages to the IP address. Web services are applications that are capable of interacting with other applications over a. communications means, such as the Internet. Web services are typically based on standards or protocols such as XML, SOAP, AJAX, WSDL and UDDI. Web services methods are well known in the art, and are covered in many standard texts. See, e.g., ALE NGHIEM, IT WEB SERVICES: A ROADMAP FOR THE ENTERPRISE (2003), hereby incorporated by reference.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBSeript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Ciyptography” by Jonathan Knudson, published by O'Reilly & Associates (1998); (3) “Cryptography & Network Security: Principles & Practice” by William Stallings, published by Prentice Hall; all of which are hereby incorporated by reference.

Computer program instructions may be loaded onto a general purpose computer, special purpose computer, or other programmable data processing apparatus to produce aa. machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity,

The system may include or interface with any of the foregoing accounts, devices, and/or a transponder and reader (e.g. MD reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RED reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field. Communication interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”, The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101,

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus,

The various embodiments described herein have been presented by way of example and not limitation. It will be apparent to persons skilled in the relevant art(s) that various changes in form and detail can be made therein (e.g., different hardware, communications protocols, and the like) without departing from the spirit and scope of the present disclosure. Thus, the present disclosure should not be limited by any of the above-described exemplary embodiments, but should be defined only in accordance with the following claims and their equivalents. It is also to be understood that the steps and processes recited in the claims need not be performed in the order presented.

In addition, it should be understood that the attached drawings, which highlight the functionality and advantages of the present disclosure, are presented as illustrative examples. The architecture of the present disclosure is sufficiently flexible and configurable, such that it may be utilized (and navigated) in ways other than that shown in the drawings.

Further, the purpose of the appended Abstract is to enable the U.S. Patent and Trademark Office and the public generally, and especially scientists, engineers, and practitioners in the relevant art(s), who are not familiar with patent or legal terms and/or phraseology, to determine quickly from a cursory inspection the nature and essence of the technical subject matter disclosed herein. The Abstract is not intended to be limiting as to the scope of the present disclosure in any way.

We claim:

1. A computer-implemented method comprising:
determining, by a computer-based system for enhancing customer service, that a consumer is within an area encompassing a merchant;
transmitting, by the computer-based system, a visual description of the consumer to the merchant; and
transmitting, by the computer-based system, consumer status information associated with the consumer to the merchant.

2. The method of claim 1, wherein the consumer status information comprises at least one of cardmember status, a social media score, a job title, an income level, prior purchasing history, a credit score, new customer status, and available credit.

3. The method of claim 1, further comprising:
determining, by the computer-based system, that the consumer has left the area; and
authorizing, by the computer-based system and in response to the determining that the customer has left the area, a transaction request associated with the consumer and the merchant.

4. The method of claim 1, further comprising transmitting, by the computer-based system, consumer preferences to the merchant.

5. The method of claim 1, further comprising receiving, by the computer-based system, a notification that the consumer is in the area.

6. The method of claim 1, wherein the transmitting the visual description comprises at least one of calling or transmitting an electronic message to the merchant.

7. The method of claim 1, further comprising analyzing, by the computer-based system, social media relationships associated with the consumer.

8. The method of claim 7, further comprising analyzing, by the computer-based system, social media relationships associated with the merchant.

9. The method of claim 8, further comprising comparing, by the computer-based system, the social media relationships associated with the consumer to the social media relationships associated with the merchant.

10. The method of claim 1, further comprising notifying, by the computer-based system, the merchant of a relationship between the consumer and the merchant.

11. The method of claim 1, further comprising determining, by the computer-based system, that the consumer satisfies offer criteria, wherein the over criteria comprises at least one of cardmember status, a social media score, job title, an income level, prior purchasing history, credit score, new customer status, and available credit.

12. The method of claim 1, further comprising transmitting, by the computer-based system, a reservation request to the merchant.

13. The method of claim 1, further comprising notifying, by the computer-based system, the merchant that the consumer has arrived.

14. The method of claim 1, further comprising enrolling, by the computer-based system, at least one of the merchant and the consumer in a customer enhancement program.

15. The method of claim 1, further comprising transmitting, by the computer-based system, a promotion to the consumer.

16. The method of claim 1, further comprising:
receiving, by the computer-based system and from the merchant, a request to offer the consumer a promotion; and
transmitting, by the computer-based system and in response to the request, the promotion to the consumer.

17. The method of claim 16, further comprising storing, by the computer-based system, a response to the promotion from the consumer and providing, by the computer-based. system, a reward to the consumer based on the response.

18. The method of claim 16, further comprising:
matching, by the computer-based system, an accepted promotion with a record of charge to a transaction account held by the consumer; and
crediting, by the computer-based system, the transaction account based upon the matching,

19. An article of manufacture including a non-transitory, tangible computer readable storage medium having instructions stored thereon that, in response to execution by a computer-based system for enhancing customer service, cause the computer-based system to perform operations comprising:
determining, by the computer-based system, that a consumer is within an area encompassing a merchant;
transmitting, by the computer-based system, a visual description of the consumer to the merchant; and
transmitting, by the computer-based system, consumer status information associated with the consumer to the merchant.

20. A system comprising:
a processor for enhancing customer service,
a tangible, non-transitory memory configured to communicate with the processor,
the tangible, non-transitory memory having instructions stored thereon that, in response to execution by the processor, cause the processor to perform operations comprising:
receiving, by the processor, a notification that a consumer is within an area encompassing a merchant;
receiving, by the processor, a visual description of the consumer;
receiving, by the processor, consumer status information associated with the consumer;
determining, by the processor, that the consumer satisfies offer criteria, wherein the offer criteria comprises at least one of cardmember status, a social media score, job title, an income level, prior purchasing history, credit score, new customer status, and available credit; and
offering, by the processor and in response to the determining that the consumer satisfies offer criteria, a promotion to the consumer.
